(19) United States
(12) Patent Application Publication
(10) Pub. No.: US 2021/0138681 A1
(43) Pub. Date: May 13, 2021

(54) STRUCTURAL ARRANGEMENT FOR AN AUXILIARY CUTTING DEVICE FOR A POWER SAW

(71) Applicants: João Francisco Galoro GARCIA, Nhandeara (BR); Pedro Augusto Galoro GARCIA, Nhandeara (BR)

(72) Inventors: João Francisco Galoro GARCIA, Nhandeara (BR); Pedro Augusto Galoro GARCIA, Nhandeara (BR)

(21) Appl. No.: 17/052,158

(22) PCT Filed: Apr. 26, 2019
(86) PCT No.: PCT/BR2019/050152

§ 371 Date: Oct. 30, 2020

(30) Foreign Application Priority Data
Apr. 30, 2018 (BR) 202018008800-4

(51) Int. Cl. B27B 17/00; B27B 17/02

(52) U.S. Cl. CPC B27B 17/0083; B27B 17/02; B27B 17/0025

(57) ABSTRACT

A new structural arrangement for an ancillary cutting device for chainsaws, pertaining to the technical sector of mechanics, particularly to the sector of cutting equipment. The device is coupled to the chainsaw to adjust the thickness of the timber to be cut. The device is secured to the body of the chainsaw or directly to the blade, and comprises a tubular body with a screw thread and nut at one end, and a channel at the opposite end that limits movement of a gauge whose positioning is set using markings on the tubular body. The gauge is formed by a sleeve having a diameter slightly larger than that of the tubular body. The sleeve has a cylindrical shoulder having a through-hole with an inner thread for receiving a fastening screw, and a support rod obliquely relative to the axis thereof

### FIELD OF THE INVENTION

The present invention is directed to a structural arrangement for an ancillary cutting device for chainsaws, pertaining to the technical sector of mechanics, more particularly to the sector of cutting equipment. The device is coupled to a chainsaw, making it possible to adjust the thickness of the timber to be cut, including timber already existing on site, and through which very advantageous practical, safe and functional results are obtained.

### BACKGROUND OF THE INVENTION

Some devices for chainsaws known in the state of the art are extremely complex and difficult to install and handle. Many of these devices are also too expensive for small farmers, look like mobile sawmills, and are very heavy.

Thus, an ancillary cutting device for chainsaws was developed, with a new structural arrangement. The device is coupled to the chainsaw blade, making it possible to adjust the thickness of the timber to be cut, thus solving the problem of the cost to saw timber. The device also allows the reutilization of timber that exists on site, therefore reducing deforestation and consequently contributing to the preservation of the environment. The present device thus overcomes the disadvantages of the state of the art, in addition to providing several advantages.

### BRIEF DESCRIPTION OF THE DRAWINGS

FIG. 1—a perspective view of the structural arrangement of an ancillary cutting device for chainsaws;

FIG. 2—a side view of the ancillary cutting device for chainsaws;

FIG. 3—a magnified view of the ancillary cutting device for chainsaws;

FIG. 4—a perspective view of the ancillary cutting device coupled to a chainsaw;

FIG. 5—a perspective view of the chainsaw with a hole in the blade; and

FIG. 6—a perspective view of the device directly attached to the blade.

### DETAILED DESCRIPTION OF THE INVENTION

As seen in FIGS. 1 to 3, the new structural arrangement for an ancillary cutting device for chainsaws comprises a tubular body (1) with a screw thread (11) and a nut (12) at a first end, where the size of the screw thread (11) is proportional to that of the screw that secures the blade (S) of the chainsaw (MS) or to a hole (f) made in the blade. At an opposite end of the tubular body (1), a channel (13) limits the movement of a gauge (2) whose positioning is set using markings (14) provided along the tubular body (1)

The gauge (2) is formed by a sleeve (21) having a diameter slightly larger than the tubular body (1), enabling the sleeve (21) to slide over the tubular body (1). The sleeve (21) has a cylindrical shoulder (22) having a through-hole with an inner thread for receiving a fastening screw (23), and a support rod (24) obliquely relative to the axis thereof As seen in FIG. 4, the assembly of the structural arrangement for an ancillary cutting device for chainsaws is quite simple. First, one of the screws with the respective nut is removed from the side of the chainsaw (MS) that attaches to the blade (S) and is replaced by the screw thread (11) of the tubular body (1). The nut (12) is fastened to the screw thread (11). The gauge (2) is then adjusted to the desired thickness of the timber that is to be cut with the aid of markings (14), and the gauge (2) is held in place using the fastening screw (23). The support rod (24) is kept parallel but inclined approximately 45 degrees relative to the blade (S). The chainsaw (MS) is then ready to cut pieces of timber having the same thickness, both precisely and in parallel. The rod (24) rests on an outer face of the timber once the timber is cut.

Optionally, the device can be assembled and attached directly to a hole (F) previously made in the blade (S) as seen in FIGS. 5 and 6. The screw thread (11) of the tubular body (1) is passed through the hole (F) and secured using the nut (12). The remaining steps of adjusting the thickness of the timber, positioning the rod (24) and cutting are carried out the same way as described above.

The new structural arrangement for an ancillary cutting device for chainsaws therefore offers the following advantages compared to those devices known in the state of the art:
the device is adaptable to any chainsaw on the market;
easy assembly and adjustment of thickness;
low cost;
the device is light and does not interfere with the handling and cutting of the chainsaw;
easy workmanship in rural properties of any size;
decreased costs as it is not necessary to purchase cut timber from saw mills and lumber yards;
the device can be used for timber that already exists on rural properties, thus diminishing deforestation; and
contribution to the preservation of the environment.

1. (canceled)

2. An ancillary cutting device for a chainsaw comprising:
a tubular body with a threaded tip;
a nut at a first end of the tubular body, and
a channel at a second end of the tubular body, the channel limiting the movement of a gauge,
wherein a position of the gauge is adjusted using markings provided along the tubular body;
wherein the gauge is formed by a sleeve having a diameter slightly larger than a diameter of the tubular body, enabling the sleeve to slide over the tubular body;
wherein the sleeve further comprises a cylindrical shoulder having a through-hole with an inner thread for receiving a fastening screw, and a support rod obliquely relative to the axis thereof; and
wherein the device is attached to a body of the chainsaw or directly to a blade of the chainsaw.
